(19) United States
(12) Patent Application Publication
(10) Pub. No.: US 2026/0196895 A1
(43) Pub. Date: Jul. 9, 2026

(54) ELECTRIC MACHINE WITH A ROTOR ASSEMBLY FOR ROTOR CORE RETENTION

(71) Applicant: Ford Global Technologies, LLC, Dearborn, MI (US)

(72) Inventors: Ethan Filip, Indian Trail, NC (US); Brandon Doolin, Farmington Hills, MI (US)

(21) Appl. No.: 19/011,328

(22) Filed: Jan. 6, 2025

(51) Int. Cl. H02K 1/30; H02K 1/276; H02K 15/023; H02K 15/0273; H02K 15/035; H02K 17/16

(52) U.S. Cl. CPC H02K 1/30; H02K 1/276; H02K 15/023; H02K 15/0273; H02K 15/035; H02K 17/168

(57) ABSTRACT

Methods and systems are provided for a rotor assembly of an electric machine. A method for manufacture of the electric machine includes, in one example, creating an undercut lip at one end of a rotor shaft via machining, arranging a rotor core lamination stack that includes multiple laminations onto the rotor shaft, and arranging a first end plate proximate to the undercut lip. The method further includes compressing the lamination stack and the first end plate and bending the undercut lip over a portion of the first end plate to form a flange providing axial retention and compression to the rotor core lamination stack.

### FIELD

The present description relates generally to an electric machine with rotor assembly that has a rotor core retention feature.

### BACKGROUND/SUMMARY

Electric machines are used in a variety of technological fields, such as in the automotive industry.

The inventors developed a method for manufacturing an electric machine. The method includes, in one example, creating an undercut lip at one end of a rotor shaft via machining, arranging a rotor core lamination stack that includes multiple laminations onto the rotor shaft, and arranging a first end plate proximate to the undercut lip. The method further includes compressing the lamination stack and the first end plate and bending the undercut lip over a portion of the first end plate to form a flange providing axial retention and compression to the plurality of rotor core laminations. In this way, the electric machine and particularly the rotor assembly is able to achieve robust axial retention of the rotor core on the rotor shaft using an efficient manufacturing process. Further, the rotor assembly formed using the aforementioned manufacturing method enables the components to be compressed by a target amount that reduces the likelihood of rotor lamination fluttering and decreases the chance of cooling oil (in the case of an oil cooled machine) leaking from the rotor laminations into the air gap between the rotor and the stator.

In one example, bending the undercut lip may include bending the lip through operation of an orbital forming tool. In this way, manufacturing efficiency of the rotor assembly is further increased, thereby increasing customer appeal.

Further, in one example, the rotor assembly formed via the abovementioned manufacturing method may be used in both electric machines that use rotors which are electromagnetically excited via permanent magnets or induction. In this way, the applicability of the rotor assembly is expanded, thereby expanding market appeal.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic of an engine system for a vehicle.

FIG. 2 shows a perspective view of a rotor assembly in an electric machine.

FIG. 3 shows a cross-sectional view of the rotor assembly, depicted in FIG. 2, prior to machining of an undercut lip of a rotor core.

FIG. 4 shows a cross-sectional view of the rotor assembly, depicted in FIG. 2, subsequent to machining of an undercut lip of a rotor core.

FIG. 5 shows an exemplary tooling for the undercut lip.

FIG. 6 shows a method for manufacture of a rotor assembly.

### DETAILED DESCRIPTION

The following description relates to electric machines with rotor assemblies that achieve a target amount of axial component retention during operation to reduce rotor fluttering. It will be understood that the electric machines described herein may be used in a wide variety of fields. To achieve desired characteristics a manufacturing technique for a rotor assembly has been developed. In one example, the manufacturing method includes arranging one or more end plates on a rotor shaft and a rotor core between or adjacent to the one or more end plate(s). The end plates and the rotor core are then compressed. The rotor shaft includes an undercut flange that is plastically or otherwise deformed to reconfigure the undercut portion to axially delimit the end plate and therefore the rotor core in relation to the shaft. The deformed undercut lip is inherently strong with the capacity to hold a large amount of force and compression as it may be constructed from the same steel as the shaft itself, in one example. The tooling to create the flange has decreased complexity (when compared to other types of tooling) and has increased tool longevity. In this way, manufacturing complexity of the rotor assembly is reduced.

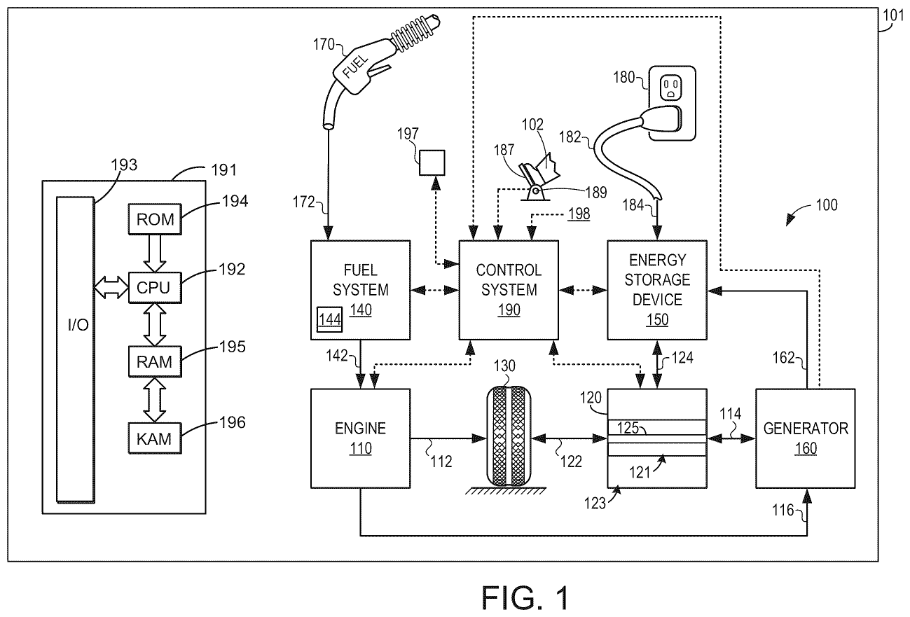

FIG. 1 illustrates an example vehicle propulsion system 100 in a vehicle 101. The vehicle propulsion system 100 includes a fuel burning engine 110 and an electric machine. As a non-limiting example, the engine 110 is an internal combustion engine (ICE). Further, in a non-limiting example, the electric machine 120 is a traction motor. The electric machine 120 includes a rotor assembly 121 and a stator assembly 123 that electromagnetically interact to generate rotational output. The rotor assembly 121 includes a rotor shaft 125 that is coupled to a downstream powertrain component.

Electric machine 120 is configured to utilize or consume a different energy source than engine 110. For example, engine 110 consumes liquid fuel (e.g., gasoline) to produce an engine output while electric machine 120 consumes electrical energy to produce a motor output. As such, the vehicle 101 with the propulsion system 100 may be a hybrid electric vehicle (HEV). In such an example, as described in greater detail herein, the vehicle 101 includes an electric motor, a traction battery, and the like. In the hybrid vehicle example, the traction motor and the engine may have a variety of suitable architectures, as discussed in greater detail herein. However, in other examples, the vehicle may be an ICE vehicle. In other examples, the vehicle 101 may be an all-electric vehicle where the powertrain solely includes the traction motor as the propulsion source.

Vehicle propulsion system 100 may utilize a variety of different operational modes depending on operating conditions encountered by the vehicle propulsion system. Some of these modes may enable the engine 110 to be maintained in an off state (e.g., set to a deactivated state) where combustion of fuel at the engine is discontinued. For example, under select operating conditions, the electric machine 120 may propel the vehicle via the drive wheel 130 as indicated by arrow 122 while engine 110 is deactivated.

During other operating conditions, the engine 110 may be set to a deactivated state (as described above) while the electric machine 120 may be operated to charge the energy storage device 150. For example, the electric machine 120 may receive wheel torque from drive wheel 130 as indicated by arrow 122 where the motor may convert the kinetic energy of the vehicle to electrical energy for storage at the energy storage device 150 as indicated by arrow 124. This operation may be referred to as regenerative speed reduction of the vehicle. Thus, the electric machine 120 can provide a generator function in some embodiments. However, in other embodiments, a generator 160 may instead receive wheel torque from the drive wheel 130, where the generator may convert the kinetic energy of the vehicle to electrical energy for storage at the energy storage device 150 as indicated by arrow 162.

During still other operating conditions, the engine 110 may be operated by combusting fuel received from a fuel system 140 as indicated by arrow 142. For example, the engine 110 may be operated to propel the vehicle via drive wheel 130 as indicated by arrow 112 while the electric machine 120 is deactivated. During other operating conditions, both the engine 110 and the electric machine 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, the electric machine 120 may propel the vehicle via a first set of drive wheels and the engine 110 may propel the vehicle via a second set of drive wheels.

In other embodiments, vehicle propulsion system 100 may be configured as a series type vehicle propulsion system, whereby the engine does not directly propel the drive wheels. Rather, the engine 110 may be operated to power the electric machine 120, which may in turn propel the vehicle via drive wheel 130 as indicated by arrow 122. For example, during select operating conditions, the engine 110 may drive the generator 160 as indicated by arrow 116, which may in turn supply electrical energy to one or more of the electric machine 120 as indicated by arrow 114 or energy storage device 150 as indicated by arrow 162. As another example, the engine 110 may be operated to drive the electric machine 120 which may in turn provide a generator function to convert the engine output to electrical energy, where the electrical energy may be stored at energy storage device 150 for later use by the motor.

The fuel system 140 may include one or more fuel storage tanks 144 for storing fuel on-board the vehicle. For example, the fuel tank(s) 144 may store one or more liquid fuels, including but not limited to: gasoline, diesel, and alcohol fuels. In some examples, the fuel may be stored on-board the vehicle as a blend of two or more different fuels. For example, the fuel tank(s) 144 may be configured to store a blend of gasoline and ethanol (e.g., E10, E85, etc.) or a blend of gasoline and methanol (e.g., M10, M85, etc.), whereby these fuels or fuel blends may be delivered to the engine 110 as indicated by arrow 142. Still other suitable fuels or fuel blends may be supplied to the engine 110, where they may be combusted at the engine to produce an engine output. The engine output may be utilized to propel the vehicle as indicated by arrow 112 or to recharge the energy storage device 150 via the electric machine 120 and/or the generator 160. The engine 110 and the other engines described herein may be configured for compression and/or spark ignition.

In some embodiments, the energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, the energy storage device 150 may include one or more batteries and/or capacitors.

Control system 190 may communicate with one or more of the engine 110, the electric machine 120, the fuel system 140, the energy storage device 150, and the generator 160. Control system 190 may receive sensory feedback information from one or more of the engine 110, the electric machine 120, the fuel system 140, the energy storage device 150, and the generator 160. Further, control system 190 may send control signals to one or more of the engine 110, the electric machine 120, the fuel system 140, the energy storage device 150, and the generator 160 responsive to this sensory feedback. The control system 190 may receive an indication of an operator requested output of the vehicle propulsion system from a vehicle operator 102. For example, the control system 190 may receive sensory feedback from a pedal position sensor 189 which communicates with a pedal 187. The pedal 187 may refer schematically to a speed adjustment pedal.

The control system 190 includes a controller 191. The controller 191 is shown in FIG. 1 as a conventional microcomputer including: microprocessor unit 192, input/output ports 193, read-only memory 194 (e.g., non-transitory memory), random access memory 195, keep alive memory 196, and a conventional data bus. Controller 191 is shown receiving various signals from sensors coupled to engine 110, in addition to those signals previously discussed, including: engine coolant temperature (ECT) from temperature sensor coupled to a cooling sleeve; a position sensor coupled to an driver demand pedal for sensing force applied by human foot; a position sensor coupled to caliper control pedal for sensing force applied by foot, a measurement of engine manifold pressure (MAP) from pressure sensor coupled to intake manifold; an engine position sensor from a position sensor sensing crankshaft position; a measurement of air mass entering the engine from sensor; and a measurement of throttle position from a sensor. Barometric pressure may also be sensed for processing by controller 191. A position sensor may produce a predetermined number of equally spaced pulses each revolution of the crankshaft from which engine speed (RPM) can be determined.

The controller 191 may receive various signals from sensors coupled to the engine 110, including measurement of manifold airflow pressure (MAP) sensor; engine coolant temperature (ECT) from temperature sensor exhaust gas air/fuel ratio from exhaust gas sensor; a crankcase pressure sensor (CKCP); BP sensor, TIP sensor, etc. Furthermore, the controller may monitor and adjust the position of various actuators based on input received from the various sensors. These actuators may include, for example, the throttle, and intake and exhaust valve systems. Storage medium read-only memory 194 can be programmed with computer readable data representing instructions executable by processor 192 for performing the methods described below, as well as other variants that are anticipated but not specifically listed.

During operation, each cylinder within engine 110 typically undergoes a four stroke cycle:
the cycle includes the intake stroke, compression stroke, expansion stroke, and exhaust stroke. During the intake stroke, generally, the exhaust valve closes and intake valve opens. Air is introduced into combustion chamber via intake manifold, and piston moves to the bottom of the cylinder so as to increase the volume within combustion chamber. The position at which piston is near the bottom of the cylinder and at the end of its stroke (e.g., when combustion chamber is at its largest volume) is typically referred to by those of skill in the art as bottom dead center (BDC).

During the compression stroke, the intake valve and the exhaust valve are closed. The piston moves toward the cylinder head so as to compress the air within the combustion chamber. The point at which the piston is at the end of its stroke and closest to the cylinder head (e.g. when the combustion chamber is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as a spark plug and/or compression ignition, resulting in combustion.

During the expansion stroke, the expanding gases push the piston back to BDC. Crankshaft converts piston movement into a rotational torque of the rotary shaft. Finally, during the exhaust stroke, the exhaust valve opens to release the combusted air-fuel mixture to the exhaust manifold and the piston returns to TDC. Note that the above is shown merely as an example, and that intake and exhaust valve opening and/or closing timings may vary, such as to provide positive or negative valve overlap, late intake valve closing, or various other examples.

The energy storage device 150 may periodically receive electrical energy from a power source 180 residing external to the vehicle (e.g., not part of the vehicle) as indicated by arrow 184. As a non-limiting example, vehicle propulsion system 100 may be configured as a plug-in HEV, whereby electrical energy may be supplied to energy storage device 150 from the power source 180 via an electrical energy transmission cable 182. During a recharging operation of the energy storage device 150 from the power source 180, the electrical transmission cable 182 may electrically couple the energy storage device 150 and the power source 180. While the vehicle propulsion system 100 is operated to propel the vehicle, electrical transmission cable 182 may be disconnected between the power source 180 and the energy storage device 150. The control system 190 may identify and/or control the amount of electrical energy stored at the energy storage device, which may be referred to as the state of charge (SOC).

In other embodiments, the electrical transmission cable 182 may be omitted, where electrical energy may be received wirelessly at the energy storage device 150 from the power source 180. For example, the energy storage device 150 may receive electrical energy from the power source 180 via one or more of electromagnetic induction, radio waves, and electromagnetic resonance. As such, it should be appreciated that any suitable approach may be used for recharging energy storage device 150 from a power source that does not comprise part of the vehicle, such as from solar or wind energy. In this way, the electric machine 120 may propel the vehicle by utilizing an energy source other than the fuel utilized by the engine 110.

The fuel system 140 may periodically receive fuel from a fuel source residing external to the vehicle. As a non-limiting example, the vehicle propulsion system 100 may be refueled by receiving fuel via a fuel dispensing device 170 as indicated by arrow 172. In some embodiments, fuel tank 144 may be configured to store the fuel received from the fuel dispensing device 170 until it is supplied to the engine 110 for combustion. In some embodiments, control system 190 may receive an indication of the level of fuel stored at the fuel tank 144 via a fuel level sensor. The level of fuel stored at the fuel tank 144 (e.g., as identified by the fuel level sensor) may be communicated to the vehicle operator 102, for example, via a fuel gauge or indication in a vehicle instrument panel 197.

The vehicle propulsion system 100 may also include an ambient temperature/humidity sensor 198, and the like. The vehicle instrument panel 197 may include indicator light(s) and/or a text-based display in which messages are displayed to an operator. The vehicle instrument panel 197 may also include various input portions for receiving an operator input, such as buttons, touch screens, voice input/recognition, etc.

The engine 110 shown in FIG. 1 may be a boosted engine that includes a turbocharger with a compressor and an exhaust drive turbine. Alternatively, the engine 110 may be naturally aspirated.

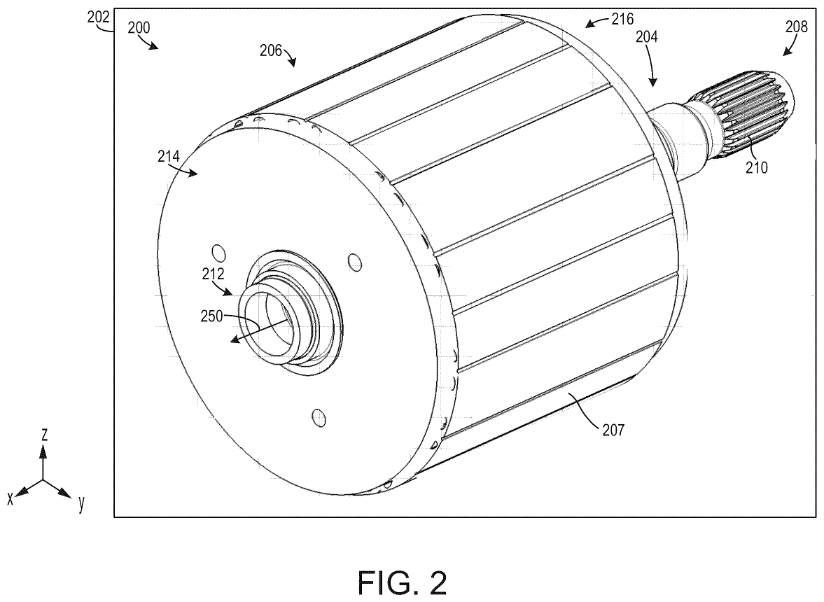

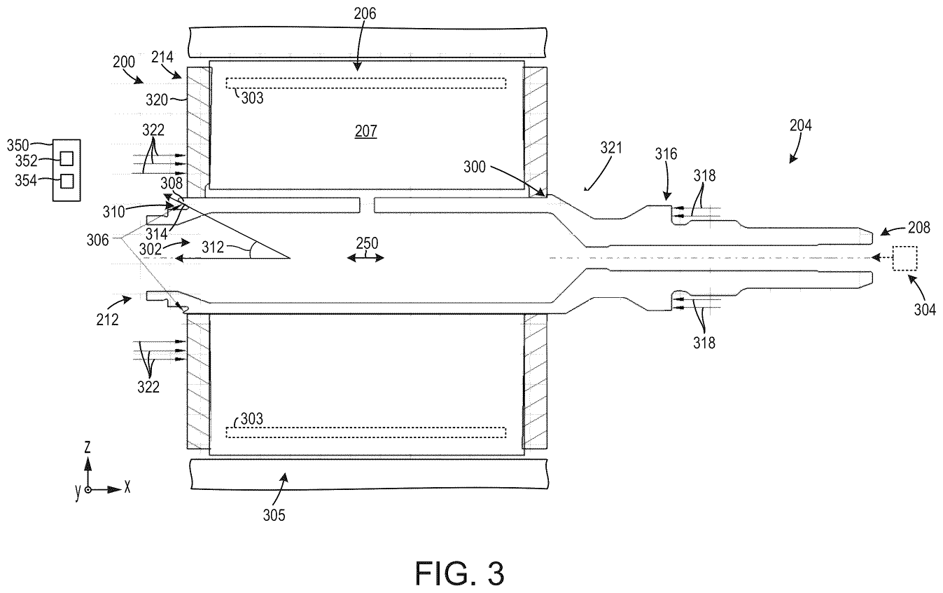

FIG. 2 shows a perspective view of a rotor assembly 200 for an electric machine 202. As discussed in greater detail herein with regard to FIG. 3, the electric machine 202 includes a stator the circumferentially surrounds the rotor assembly and forms an air gap therebetween, in the illustrated example. The rotor assembly serves as an example of the rotor assembly 121, shown in FIG. 1, in the electric powertrain or another suitable system.

The rotor assembly 200 includes a rotor shaft 204 and a rotor core 206 coupled thereto. The manufacturing method used to form the rotor assembly 200 is expanded upon herein with regard to FIGS. 3-6.

The rotor shaft 204 includes one end 208 with a splined interface 210, in the illustrated example. In this way, the rotor shaft 204 can be rotationally coupled to downstream components in an electric powertrain or other suitable system. However, the rotor shaft 204 may include additional or alternative structural features of the rotor shaft that allow for attachment to downstream components such as a flange, a section designed for press-fitting, and the like. Another end 212 of the rotor shaft 204 is further depicted in FIG. 2. The rotor assembly 200 includes components coupled to the rotor shaft 204 using the method that is expanded upon herein. Specifically, the rotor core 206 and end plates 214 and 216 are coupled to the rotor shaft 204. The rotor core 206 is positioned axially between the end plates 214 and 216, in the illustrated example.

The rotor core 206 includes a stack of rotor laminations 207 that includes multiple laminations which are sequentially arranged in face sharing contact with one another. The rotor laminations in the stack are constructed out of steel such as electrical steel (e.g., silicon steel), in the illustrated example. Further, the rotor shaft is constructed out of steel such as electrical steel (e.g., silicon steel). The end plates 214 and 216 may be constructed out of a metal such as steel, aluminum, and the like.

An axis system is provided in FIG. 2 as well as FIGS. 3-5, for reference. The z-axis may be a vertical axis (e.g., parallel to a gravitational axis), the x-axis may be a longitudinal axis (e.g., horizontal axis), and/or the y-axis may be a lateral axis, in one example. However, the axes may have other orientations, in other examples. A rotational axis 250 of the rotor shaft 204 is further depicted in FIGS. 2 and 3-5 for reference.

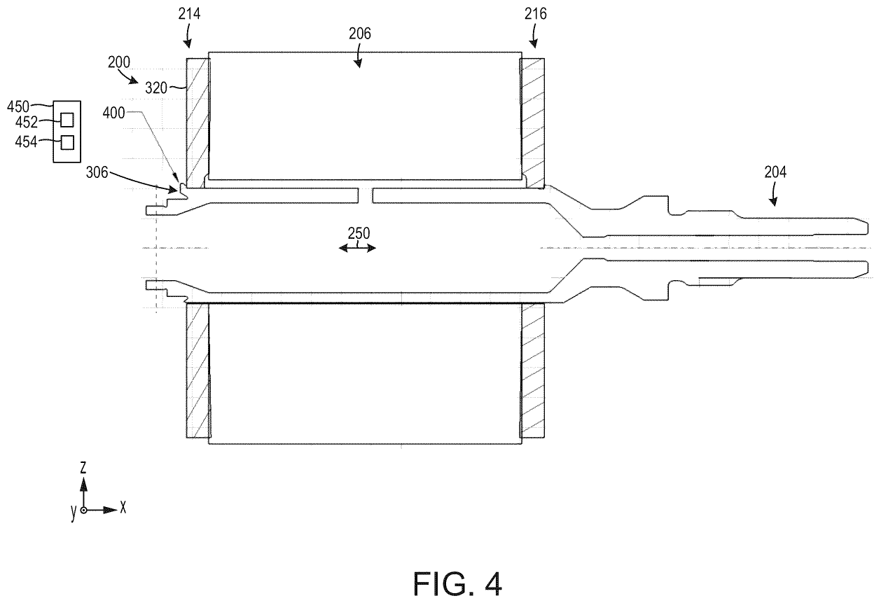

FIGS. 3-4 show a manufacturing sequence for forming the rotor assembly 200. Specifically, FIG. 3 shows the rotor assembly 200 prior to the formation of a flange from an undercut lip of the rotor shaft and FIG. 4 shows the rotor assembly subsequent to forming the flange from the undercut lip of the rotor shaft.

The end plates 214 and 216, the rotor core 206, and the rotor shaft 204 are again illustrated in FIG. 3. The rotor shaft 204 may include a step 300 that axially delimits the end plate 216. However, in other examples, the step may be omitted from the rotor shaft 204.

In the illustrated example, the rotor shaft 204 includes a central opening 302 that extends from the end 212 to the end 208. However, different rotor shaft constructions have been contemplated. In one specific example, a cooling system 304 may direct coolant (e.g., oil) through the central opening 302 and from the central opening oil may be directed into conduits in the rotor core 206. The cooling system 304 may include components designed to circulate the coolant through the system such as a pump, a sump that may be incorporated into a housing of the electric machine, a filter, and the like.

The rotor core 206 includes the stack of rotor laminations 207 (e.g., steel laminations), as previously indicated. Further, in one example, the rotor core 206 may include permanent magnets 303 that are embedded in the lamination stack. Alternatively, the rotor core 206 may be configured for electromagnetic induction via a stator assembly 305. In such an example, the end plates 214 and 216 may be omitted from the rotor assembly, in certain cases.

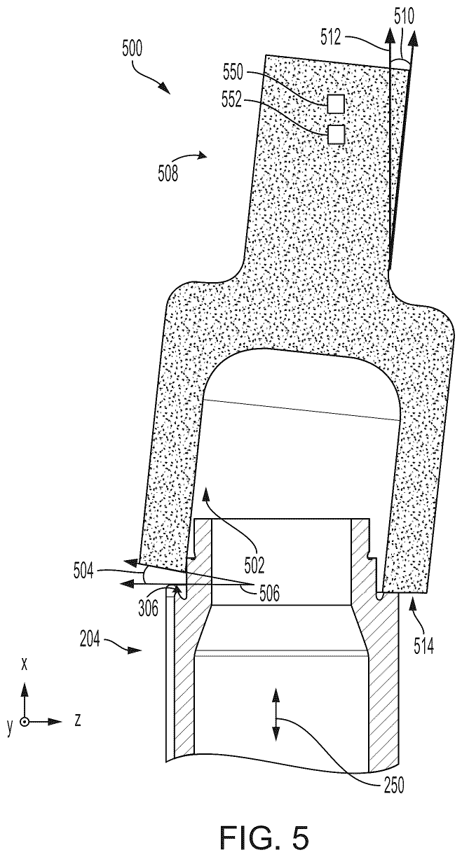

The rotor shaft 204 includes an undercut lip 306 that is adjacent to the end plate 214. Specifically, a protrusion 308 of the undercut lip 306 is positioned radially inward from the end plate 214, in the pre-forming step depicted in FIG. 3, prior to the undercut lip 306 being bent to axially retain the end plates and the rotor core on the rotor shaft. The bending step of the undercut lip is elaborated upon herein with regard to FIGS. 4-5.

To elaborate, the undercut lip 306 includes the protrusion 308 and a recess 310. An angle 312 of the surface 314 of the undercut may be between 10°-40°, in one example. It will be appreciated that the undercut lip 306 circumferentially extends around the body of the rotor shaft 204, in the illustrated example. However, in other examples. The undercut lip may be divided into segments. For instance, the rotor shaft may include two undercut lip segments that have a 30°-70° span, in other embodiments.

During construction of the rotor assembly 200, the end plate 216 is mated with the rotor shaft 204. Subsequently, the rotor core 206 is mated with the rotor shaft 204. Next, the end plate 214 is mated with the rotor shaft 204. After, both end plates and the core are mated with the rotor shaft, a compressive force is applied to assembly of the end plates 214 and 216 as well as the rotor core 206. To elaborate, the rotor shaft 204 includes a flange 316 in the illustrated example that has the compressive force applied thereto (as indicated via arrows 318). Further, in the illustrated example, the end plate 214 includes an outer face 320 that has the compressive force applied thereto (as indicated via arrows 322). In this way, the stack of rotor laminations 207 and the end plates 214 and 216 are loaded onto the rotor shaft 204 and compressed. Additionally, in the illustrated example, the rotor shaft 204 may include a tapered section 321 that increases in diameter in a direction toward the end plate 216.

A tool 350 is further shown in FIG. 3. It will be understood that the tool 350 may be used to machine the recess in the undercut lip 306, prior to bending of the lip via an orbital tool that is discussed in greater detail herein with regard to FIGS. 4-5. As shown in FIG. 3, the tool 350 includes a processor 352 (e.g., a microprocessor unit) and memory 354 that hold instructions to implement at least a portion of the manufacturing steps described herein. To elaborate, the tool 350 may be used to machine the undercut lip 306 and/or compress the end plates 214 and 216 and the rotor core 206. Alternatively, another tool may be used to compress the end plates and the rotor core.

FIG. 4 shows the rotor assembly 200 subsequent to a manufacturing step where the undercut lip 306 is rotary tooled or otherwise manipulated to form a bent portion 400 that contacts an outer face 320 of the end plate 214. A tool 450 (e.g., an orbital tool) is further shown in FIG. 4. It will be understood that the tool 450 may bend the undercut lip 306. The tool 450 includes a processor 452 (e.g., a microprocessor unit) and memory 454 that hold instructions to implement at least a portion of the manufacturing steps described herein. To elaborate the tool 450 may be used to bend the undercut lip 306, as previously indicated. FIG. 4 again shows the rotor core 206, the rotor shaft 204, and the end plate 216.

FIG. 5 shows a step in the rotor assembly manufacturing process where the bent portion 400 (shown in FIG. 4) of the undercut lip 306 of the rotor shaft 204 is formed via a rotary tool 500 that includes a cup shaped portion 502. To elaborate, the cup shaped portion 502 is oriented at a shallow angle 504 in relation to a horizontal axis 506. A shank 508 of the tool 500 is also arranged at an angle 510 in relation to a vertical axis 512. The angle 504 may twice the angle 510, in one example.

Further, in the illustrated example, a conical face 514 of the rotary tool 500 matches the axis offset angle so as to have a flat contact with the rotor shaft when pressing against it at the undercut location. Thus, the conical face 514 is horizontally arranged in the illustrated example. It will be appreciated that the tooling shown in FIG. 5 may occur while the end plates and the rotor core are under compression. As the rotary tool 500 spins and compresses, the bent portion 400 (e.g., flange), shown in FIG. 4, is formed by plastically deforming the shaft and deforming the undercut portion. This formed flange does not demand the use of additional components, if desired. It will be understood that the flange is inherently comparatively strong with the capacity to hold a large amount of force and compression as it may be created from the same steel as the shaft itself. The tooling to create this flange may be implemented in a relatively simple manufacturing process that allows the tool to have a large lifespan. Further, the undercut lip may be machined in a simple manner, further decreasing manufacturing complexity. The rotary tool 500 again includes a processor 550 (e.g., a micro-processor unit) and memory 552 that holds instructions that are executable by the processor to perform at least some of the manufacturing method steps described herein.

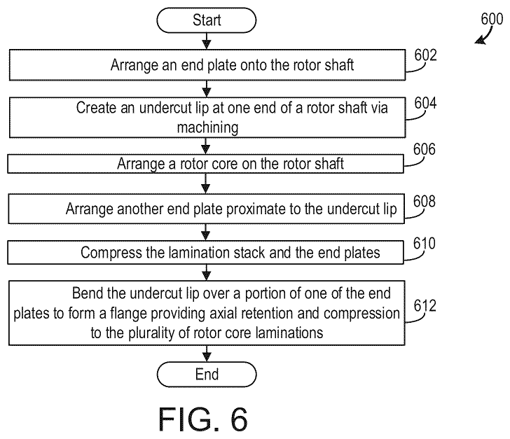

FIG. 6 shows a method 600 for manufacture of a rotor assembly. The rotor assembly may be any of rotor assemblies or combinations of the rotor assemblies described with regard to FIGS. 1-5 or another suitable rotor assembly. The method 600 may be implemented by the tools or combinations of the tools discussed above with regard to FIGS. 1-5, in one example. However, in other examples, the method 600 may be implemented via other suitable tools. Further, it will be understood that that method steps may be carried out as instructions stored in memory that is executable via one or more processor(s). The memory and the processors may be included in one or more tools. Additionally or alternatively, a portion of the method steps may be implemented via manufacturing personnel.

At 602, the method includes arranging a second end plate onto the rotor shaft. For instance, one end plate may be mounted on the rotor shaft via a tool, in one example. Next at 604, the method includes creating an undercut lip at one end of a rotor shaft. For instance, creating the undercut lip may include machining the undercut lip on the shaft via a machining tool. In other examples, step 604 may be implemented prior to step 602.

Next at 606, the method includes arranging a rotor core lamination stack that includes multiple laminations onto the rotor shaft. For instance, arranging the rotor core lamination stack onto the rotor shaft includes interference fitting, transition fitting, or clearance fitting the rotor core lamination stack onto the rotor shaft, in different examples.

Next at 608, the method includes arranging another end plate proximate to the undercut lip. For instance, another end plate may be mounted on the rotor shaft via a tool, in one example.

Next at 610, the method includes compressing the lamination stack and the end plates. For instance, step 610 may specifically include simultaneously applying an axial force to the end plate that is adjacent to the undercut lip and the rotor shaft.

At 612, the method further includes bending the undercut lip over a portion of one of the end plates to form a flange providing axial retention and compression to the multiple rotor core laminations. For instance, step 612 may specifically include bending the lip through operation of an orbital forming tool. Method 600 enables the rotor assembly (which securely retains rotor core and the end plates on the rotor shaft) to be efficiently manufactured.

FIGS. 2-5 are shown approximately to scale. However, the components may have other relative dimensions, in alternate embodiments.

FIGS. 1-5 show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As one embodiment, a method for manufacturing an electric machine is provided that comprises creating an undercut lip at one end of a rotor shaft via machining; arranging a rotor core lamination stack that includes multiple laminations onto the rotor shaft; arranging a first end plate proximate to the undercut lip; compressing the lamination stack and the first end plate; and bending the undercut lip over a portion of the first end plate to form a flange providing axial retention and compression to the rotor core lamination stack. In one example, arranging the plurality of rotor core laminations onto the rotor shaft may include transition fitting the rotor core lamination stack onto the rotor shaft. In another example, the method may further comprise, prior to arranging the rotor core lamination stack onto the rotor shaft, arranging a second end plate onto the rotor shaft. In yet another example, the second end plate may abut a step in the rotor shaft. In another example, the rotor core lamination stack may include a plurality of permanent magnets. In yet another example, the rotor core lamination stack may be configured for electromagnetic induction via a stator assembly. In yet another example, compressing the lamination stack may include simultaneously applying an axial force to the first end plate and the rotor shaft. In another example, bending the undercut lip may include bending the lip through operation of an orbital forming tool. In another example, creating the undercut lip may include machining the undercut lip on the shaft. In another example, the rotor shaft may include a splined interface. In another example, arranging the rotor core lamination stack onto the rotor shaft may include interference fitting, transition fitting, or clearance fitting the rotor core lamination stack onto the rotor shaft.

In another embodiment, an electric machine is provided that comprises a rotor assembly including: a lamination stack arranged axially between a first end plate and a second end plate; and a rotor shaft mated with the lamination stack, the first end plate, and the second end plate; where the rotor shaft includes an undercut lip that includes a bent portion that contact the first end plate. In one example, the lamination stack, the first end plate, and the second end plate are preloaded via the bent portion of the undercut lip. In another example, the second end plate may abut a step in the rotor shaft. In another example, the rotor core lamination stack may include a plurality of permanent magnets. In another example, the rotor core lamination stack may be included in a rotor core that electromagnetically excited via induction.

In another embodiment, a method for manufacturing an electric machine is provided that comprises arranging a first end plate on a rotor shaft; machining an undercut lip at one end of the rotor shaft via machining; arranging a rotor core lamination stack that includes multiple laminations onto the rotor shaft; arranging a second end plate proximate to the undercut lip; compressing the lamination stack and the first end plate; and bending the undercut lip over a portion of the second end plate, via operation of an orbital forming tool, to form a flange that provides axial retention and compression to the lamination stack, the first end plate, and the second end plate. In one example, the rotor core lamination stack may include a plurality of permanent magnets. In another example, the rotor core lamination stack may be included in a rotor core that is electromagnetically excited via induction. In yet another example, compressing the lamination stack may include simultaneously applying an axial force to the first end plate and the rotor shaft. In another example, the rotor shaft may include a splined interface.

In another representation, a rotor system for a traction motor is provided that comprises a rotor shaft with a bent undercut that has been deformed to axially delimit a rotor core that includes a compressed steel lamination stack.

Note that the example control and manufacturing routines included herein can be used with various engine and/or vehicle system configurations. The control and manufacturing methods, routines, etc. disclosed herein may be stored as executable instructions in non-transitory memory and may be carried out by the control or manufacturing systems that include the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the system, where the described actions are carried out by executing the instructions in a system including the various hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to powertrains with different types of traction motor and/or engines (in the case of hybrid powertrains) such as V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for manufacturing an electric machine, comprising:
creating an undercut lip at one end of a rotor shaft;
arranging a rotor core lamination stack that includes multiple laminations onto the rotor shaft;
arranging a first end plate proximate to the undercut lip;
compressing the rotor core lamination stack and the first end plate; and
bending the undercut lip over a portion of the first end plate to form a flange providing axial retention and compression to the rotor core lamination stack.

2. The method of claim 1, where arranging the rotor core lamination stack onto the rotor shaft includes interference fitting, transition fitting, or clearance fitting the rotor core lamination stack onto the rotor shaft.

3. The method of claim 1, further comprising, prior to arranging the rotor core lamination stack onto the rotor shaft, arranging a second end plate onto the rotor shaft.

4. The method of claim 3, where the second end plate abuts a step in the rotor shaft.

5. The method of claim 1, where the rotor core lamination stack includes a plurality of permanent magnets.

6. The method of claim 1, where the rotor core lamination stack is configured for electromagnetic induction via a stator assembly.

7. The method of claim 1, where compressing the rotor core lamination stack includes simultaneously applying an axial force to the first end plate and the rotor shaft.

8. The method of claim 1, where bending the undercut lip includes bending the undercut lip through operation of an orbital forming tool.

9. The method of claim 1, where creating the undercut lip includes machining the undercut lip on the rotor shaft.

10. The method of claim 1, where the rotor shaft includes a splined interface.

11. An electric machine, comprising:
a rotor assembly including:
a rotor core lamination stack arranged axially between a first end plate and a second end plate; and
a rotor shaft mated with the rotor core lamination stack, the first end plate, and the second end plate;
where the rotor shaft includes an undercut lip that includes a bent portion that contact the first end plate.

12. The electric machine of claim 11, where the rotor core lamination stack, the first end plate, and the second end plate are preloaded via the bent portion of the undercut lip.

13. The electric machine of claim 12, where the second end plate abuts a step in the rotor shaft.

14. The electric machine of claim 11, where the rotor core lamination stack includes a plurality of permanent magnets.

15. The electric machine of claim 11, where the rotor core lamination stack is included in a rotor core that is excited via induction.

16. A method for manufacturing an electric machine, comprising:
arranging a first end plate on a rotor shaft;
machining an undercut lip at one end of the rotor shaft via machining;
arranging a rotor core lamination stack that includes multiple laminations onto the rotor shaft;
arranging a second end plate proximate to the undercut lip;
compressing the rotor core lamination stack and the first end plate; and
bending the undercut lip over a portion of the second end plate, via operation of an orbital forming tool, to form a flange that provides axial retention and compression to the rotor core lamination stack, the first end plate, and the second end plate.

17. The method of claim 16, where the rotor core lamination stack includes a plurality of permanent magnets.

18. The method of claim 16, where the rotor core lamination stack is included in a rotor core that is excited via induction.

19. The method of claim 16, where compressing the rotor core lamination stack includes simultaneously applying an axial force to the first end plate and the rotor shaft.

20. The method of claim 19, where the rotor shaft includes a splined interface.
